(19) United States
(12) Patent Application Publication
(10) Pub. No.: US 2025/0201888 A1
(43) Pub. Date: Jun. 19, 2025

(54) INSULATING MANIFOLD FOR ELECTROCHEMICAL REACTIONS WITH EXTERNAL GAS SUPPLY AND ELECTROCHEMICAL REACTION SYSTEM WITHOUT ELECTRICAL CONTACT BETWEEN STACK AND MANIFOLD

(71) Applicants: UIF (University Industry Foundation), Yonsei University, Seoul (KR); INDUSTRY ACADEMY COOPERATION FOUNDATION OF SEJONG UNIVERSITY, Seoul (KR)

(72) Inventors: Jong Sup HONG, Seoul (KR); Dong Hun RYU, Seoul (KR); Jun Young PARK, Seongnam-si (KR)

(73) Assignees: UIF (University Industry Foundation), Yonsei University, Seoul (KR); INDUSTRY ACADEMY COOPERATION FOUNDATION OF SEJONG UNIVERSITY, Seoul (KR)

(21) Appl. No.: 18/975,688

(22) Filed: Dec. 10, 2024

(30) Foreign Application Priority Data
Dec. 13, 2023 (KR) 10-2023-0180359

(51) Int. Cl. H01M 8/2485; C25B 9/77; C25B 15/08; H01M 8/04082; H01M 8/2432; H01M 8/2475; H01M 8/248

(52) U.S. Cl. CPC H01M 8/2485; C25B 9/77; C25B 15/08; H01M 8/04201; H01M 8/2432; H01M 8/2475; H01M 8/248

(57) ABSTRACT

Disclosed are an insulating manifold for electrochemical reaction configured to receive gas from an external source, and an electrochemical reaction system in which there is no electrical contact between a stack and a manifold. The insulating manifold for the electrochemical reaction includes a plate-shaped base manifold having at least a first fluid conduit and a second fluid conduit extending therethrough vertically; a housing disposed on top of the base manifold and having a vertical wall and an open bottom surface, wherein a lower edge of the housing is coupled to a top of the base manifold; and upper and lower insulating plates respectively defining an upper surface and a lower surface of an inner space defined by the base manifold and the housing.

### CROSS-REFERENCE TO RELATED APPLICATION(S)

This application claims the benefit under 35 USC 119 (a) of Korean Patent Application No. 10-2023-0180359, filed with the Korean Intellectual Property Office on Dec. 13, 2023, the disclosure of which is incorporated herein by reference in its entirety.

### BACKGROUND

### Field

The present disclosure relates to an insulating manifold for electrochemical reaction configured to receive gas from an external source, and to an electrochemical reaction system in which there is no electrical contact between a stack and a manifold.

### Description of Related Art

A significant amount of energy in the world is produced from hydrocarbon fuels (oil, coal, natural gas) or nuclear power. However, these cause environmental problems and waste disposal problems. To solve this problem, technology development for the transition to a carbon-free hydrogen energy society is actively underway. In this trend, solid oxide fuel cell (SOFC) and solid oxide water electrolysis cell (SOEC) technologies are attracting attention. SOFC produces electricity via the reaction of hydrogen and oxygen ions, and SOEC produces green hydrogen by decomposing water vapor. In these technologies, unit cells, current collectors, sealants, and separators are alternately stacked on top of each other, and the reactants migrate to the porous electrodes via the separators. Furthermore, a scheme in which multiple unit cells are vertically stacked to increase power generation capacity and hydrogen production is employed.

A scheme of supplying reaction gas to each of SOFC and SOEC stacks is classified into an internal manifold scheme and an external manifold scheme. In the internal manifold scheme, the reaction gas is supplied via the inside of the separator, and a stack configuration is relatively simple and an additional flow path outside the stack is not required. However, in this scheme, the performance and durability may deteriorate due to the interlayer thermal/chemical gradient. On the other hand, in the external manifold scheme, the reaction gas is supplied through a flow area outside the separator, which makes the stack configuration more complex and requires additional flow paths, insulating, and fastening structures. However, this scheme relieves the interlayer thermal/chemical gradient, makes the flow distribution uniform, reduces the overall temperature deviation of the stack, and induces a more uniform electrochemical reaction.

### SUMMARY

In the conventional technology, the external manifold is directly coupled to the stack, and efficient placement of the manifold and the sealing of the manifold are mainly achieved. On the other hand, the present disclosure breaks away from this traditional approach scheme and proposes a new scheme of introducing an external manifold design that surrounds the entire stack to avoid direct coupling between the manifold and the stack, to reduce the risk of the electrical short circuit, and to improve the stability and durability of the system.

The conventional technology presents a simple obstacle installation design that forces the reaction gas to flow into the channel, rather than providing a detailed design for reaction gas distribution or thermal management. In contrast thereto, the present disclosure provides a more sophisticated and efficient design that may deal with various operating conditions. The simple obstacle installation scheme of the conventional technology may worsen the temperature distribution of the stack, while the present disclosure focuses on solving this problem and improving the overall performance and efficiency of the stack.

A purpose of the present disclosure is to solve various problems that occur when using an external manifold. The use of the external manifold complicates the structure and shape due to the formation of additional flow paths, and carries various types of risks. Therefore, the present disclosure aims to provide an external manifold design that does not change in the joint strength despite thermal expansion. Furthermore, a design that minimizes the contact between the stack and the external manifold and reduces the risk of electrical short-circuiting is required. For stable operation, a smooth supply of oxygen is required, and in particular, it is important to solve problems such as delamination of the air electrode and formation of undesirable phases due to high oxygen partial pressure in SOEC operation, and degradation of electrochemical reaction and reduction of stack cooling effect due to insufficient oxygen supply in SOFC operation.

One aspect of the present disclosure provides an insulating manifold for an electrochemical reaction, wherein the insulating manifold is configured to receive gas from an external source, wherein the insulating manifold comprises: a plate-shaped base manifold having at least a first fluid conduit and a second fluid conduit extending therethrough vertically; a housing disposed on top of the base manifold and having a vertical wall and an open bottom surface, wherein a lower edge of the housing is coupled to a top of the base manifold; and upper and lower insulating plates respectively defining an upper surface and a lower surface of an inner space defined by the base manifold and the housing.

In accordance with some embodiments of the insulating manifold for the electrochemical reaction, the housing includes: a first housing portion having an open bottom surface and having an open inner side surface and a closed outer side surface, wherein a lower edge of the first housing portion is coupled to the top of the base manifold; and a second housing portion adjacent to the first housing portion in a horizontal direction, wherein the second housing portion has an open bottom surface and has an open inner side surface and a closed outer side surface opposite to the closed outer side surface of the first housing portion, wherein a lower edge of the second housing portion is coupled to the top of the base manifold, wherein the first housing portion and the second housing portion are coupled to each other such that the open inner side surfaces thereof face each other and communicate with each other.

In accordance with some embodiments of the insulating manifold for the electrochemical reaction, the base manifold and the housing are coupled to each other via a male-female coupling structure.

In accordance with some embodiments of the insulating manifold for the electrochemical reaction, the base manifold has a rail structure constructed to guide a sliding movement of each of the first housing portion and the second housing portion, wherein the rail structure includes both opposing rail structures respectively extending along and on both opposing sides of an upper surface of the base manifold, wherein both opposing lower edges of each of the first housing portion and the second housing portion are constructed to be slidably engaged with the both opposing rail structures, respectively.

Another aspect of the present disclosure provides an electrochemical reaction system comprising: the insulating manifold of the first aspect as described above; and a stack received in the inner space so as to be disposed between the upper and lower insulating plates, wherein the stack is positioned so as not to cover at least one of the first fluid conduit or the second fluid conduit, wherein an upper sealing is disposed between the upper insulating plate and the housing, wherein a lower sealing is disposed between the lower insulating plate and the base manifold, wherein the stack includes a vertical arrangement of electrochemical cells, wherein the stack of the electrochemical cells includes a plurality of plate-shaped electrodes and a separator plate separating the plurality of plate-shaped electrodes from each other, wherein there is no electrical contact between the stack and the insulating manifold.

In accordance with some embodiments of the electrochemical reaction system, the electrochemical cell includes a SOFC (Solid Oxide Fuel Cell) or a SOEC (Solid Oxide Electrolysis Cell).

In accordance with some embodiments of the electrochemical reaction system, the base manifold is formed in a rectangular, circular, oval, or partially round shape.

In accordance with some embodiments of the electrochemical reaction system, a pressing structure is further disposed on top of the stack and/or under the stack.

In accordance with some embodiments of the electrochemical reaction system, the at least one fluid conduit not covered with the stack among the first fluid conduit and the second fluid conduit includes a plurality of fluid conduits, wherein the system further includes a flow resistance structure constructed to at least partially block fluid flow from at least some of the plurality of fluid conduits to the others thereof.

In accordance with some embodiments of the electrochemical reaction system, the flow resistance structure includes: a first flow resistance structure disposed on one of at least some of layers of the stack and the housing; and a second flow resistance structure disposed on the other of the at least some of the layers of the stack and the housing.

In accordance with some embodiments of the electrochemical reaction system, the flow resistance structure further includes an insulating portion disposed between the first flow resistance structure and the second flow resistance structure.

In accordance with some embodiments of the electrochemical reaction system, the first flow resistance structure and the second flow resistance structure are movable relative to each other.

In accordance with some embodiments of the electrochemical reaction system, the relative movement between the first flow resistance structure and the second flow resistance structure is implemented using a pinion extending in a direction perpendicular to a direction of the relative movement and a rack structure a gear meshing with the pinion.

Specifically, the present disclosure provides an external manifold design with a simplified structure and shape. This design minimizes the contact between the stack and the external manifold, reduces the risk of electrical short-circuiting, and does not have change in the joint strength despite thermal expansion. In particular, the external manifold design of introducing a ‘contactless housing’ structure to surround the stack is a feature of the present disclosure. Furthermore, the present disclosure provides a fixed flow resistance structure, thereby integrating a structure of maintaining a constant flow resistance regardless of stack operating conditions with the separator. The system of the present disclosure includes a variable flow resistance structure, which may variably adjust the flow resistance depending on stack operating conditions, and operates so as to control the pressure drop outside the stack for stack cooling under heating operating conditions, or does not branch air out of the stack to reduce stack cooling effects when the operating condition is not the heating operating condition.

The external manifold design of the present disclosure does not directly attach the manifold to the stack, unlike the existing manifold structure. The stack housing surrounds the entire stack, thereby providing a structure that does not change in fastening strength even under high-temperature operating conditions. This reduces the risk of electrical short circuits in the existing manifold design, and enables stable operation. The stack housing has a protrusion on the outer side thereof which is fastened to the base manifold using a structure such as bolts/nuts, and may also cope with the pressing structure existing on the top of the commercial stack. Furthermore, the flow resistance structure is controlled to allow the inflow of air into the side surface of the stack. This is performed so as not to (entirely) block the air flow path. The amount of air flowing into the channel is determined based on the pressure drop in the channel and the pressure drop in the external flow path to the stack.

The marketability and expected effects of the present disclosure focus on improving the performance and durability of fuel cells and water electrolysis-based cells. This is because maintaining a uniform temperature distribution in the stack plays an important role in improving the efficiency of the solid oxide fuel cell (SOFC) and solid oxide water electrolysis cell (SOEC). The conventional external manifold stack adopts a design in which the manifold is fastened to the stack itself. However, this scheme may cause problems such as electrical short circuits and weakening of the fastening strength. The present disclosure proposes use of a housing-type external manifold and a variable flow structure to solve these problems, thereby reducing the risk of the existing design and making it applicable to various operating conditions. Thus, it is expected that the marketability of the fuel cells and water electrolysis cells may be significantly increased by uniformizing the temperature distribution in the stack and improving performance and durability.

In addition to the above-described effects, the specific effects of the present disclosure are described together with the specific details for carrying out the disclosure as set forth below.

### BRIEF DESCRIPTION OF DRAWINGS

FIG. 1 is a diagram showing an example of an electrochemical reaction system according to an embodiment of the present disclosure.

FIG. 2A is a diagram showing an assembled state of a manifold.

FIG. 2B is a diagram showing a disassembled state of a manifold.

FIG. 2C is a diagram showing a cross-section of a manifold.

FIG. 3A is a diagram showing a scheme of supplying fuel to a stack of the electrochemical reaction system according to an embodiment of the present disclosure.

FIG. 3B is a diagram showing a scheme of supplying air to a stack of the electrochemical reaction system according to an embodiment of the present disclosure.

FIG. 4 is a diagram illustrating an example of a manifold with an oval shape.

FIG. 5 is a diagram illustrating an example of a manifold with a circular shape.

FIG. 6 is a diagram illustrating an example of a manifold with a partially round shape.

FIG. 7 is a diagram showing an example of a scheme of coupling a base manifold and a housing to each other.

FIG. 8 is a diagram illustrating the coupling method between the housing and the base manifold in the electrochemical reaction system.

FIG. 9 is a diagram illustrating the coupling process between the housing and the base manifold in the electrochemical reaction system.

FIG. 10A is a perspective view illustrating the arrangement of an example of a flow resistance structure that impedes or blocks flow of fluid in the electrochemical reaction system of the present disclosure.

FIG. 10B is a plan view showing the structure of the flow resistance structure.

FIG. 11A is a perspective view illustrating the arrangement of another example of a flow resistance structure in the electrochemical reaction system of the present disclosure.

FIG. 11B is a plan view showing the structure of the flow resistance structure.

FIG. 12 is a diagram illustrating an example of a flow resistance structure implemented using a rack-and-pinion gear system within the electrochemical reaction system of the present disclosure.

FIG. 13 is a diagram illustrating the operation of the flow resistance structure using a rack-and-pinion gear system within the electrochemical reaction system of the present disclosure.

FIG. 14 is a diagram illustrating the operation of the rack-and-pinion gear system controlled by an external driving force transmitted through a universal joint in the electrochemical reaction system of the present disclosure.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in the present disclosure, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to” or “coupled to” another element or layer, it may be directly connected to or coupled to the other element or layer, or one or more intervening elements or layers may be present therebetween. In addition, it will also be understood that when an element or layer is referred to as being “between” two elements or layers, it may be the only element or layer between the two elements or layers, or one or more intervening elements or layers may also be present.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, regions, layers and/or periods, these elements, components, regions, layers and/or periods should not be limited by these terms. These terms are used to distinguish one element, component, region, layer or section from another element, component, region, layer or period. Thus, a first element, component, region, layer or section as described under could be termed a second element, component, region, layer or period, without departing from the spirit and scope of the present disclosure.

When an embodiment may be implemented differently, functions or operations specified within a specific block may be performed in a different order from an order specified in a flowchart. For example, two consecutive blocks may actually be performed substantially simultaneously, or the blocks may be performed in a reverse order depending on related functions or operations.

The features of the various embodiments of the present disclosure may be partially or entirely combined with each other, and may be technically associated with each other or operate with each other. The embodiments may be implemented independently of each other and may be implemented together in an association relationship.

In interpreting a numerical value, the value is interpreted as including an error range unless there is no separate explicit description thereof. In the context of the present disclosure, the term “about” may mean about ±1%, about ±2%, about ±3%, about ±4%, about ±5%, about ±6%, about ±7%, about ±8%, about ±9%, or about ±10% of a value stated herein.

It will be understood that when an element or layer is referred to as being “coupled to”, or “coupled to” another element or layer, it may be directly on, coupled to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, and the like should not be construed such that any aspect or design as described is superior to or advantageous over other aspects or designs.

Further, the term ‘or’ means ‘inclusive or’ rather than ‘exclusive or’. That is, unless otherwise stated or clear from the context, the expression that ‘x uses a or b’ means any one of natural inclusive permutations.

The terms used in the description as set forth below have been selected as being general and universal in the related technical field. However, there may be other terms than the terms depending on the development and/or change of technology, convention, preference of technicians, etc. Therefore, the terms used in the description as set forth below should not be understood as limiting technical ideas, but should be understood as examples of the terms for illustrating embodiments.

Further, in a specific case, a term may be arbitrarily selected by the applicant, and in this case, the detailed meaning thereof will be described in a corresponding description period. Therefore, the terms used in the description as set forth below should be understood based on not simply the name of the terms, but the meaning of the terms and the contents throughout the detailed descriptions.

One aspect of the present disclosure provides an insulating manifold for an electrochemical reaction, wherein the insulating manifold is configured to receive gas from an external source, wherein the insulating manifold comprises: a plate-shaped base manifold having at least a first fluid conduit and a second fluid conduit extending therethrough vertically; a housing disposed on top of the base manifold and having a vertical wall and an open bottom surface, wherein a lower edge of the housing is coupled to a top of the base manifold; and upper and lower insulating plates respectively defining an upper surface and a lower surface of an inner space defined by the base manifold and the housing.

In the context of the present disclosure, the housing having the vertical wall and the open bottom surface is designed to be similar to a box or container having the open bottom surface. The open bottom surface of the housing is oriented to face the base manifold. The stack may be received into the housing through the open bottom surface.

In the context of the present disclosure, the meaning of the manifold refers to a valve and piping system that efficiently supplies and discharges fluid. This insulating manifold is made of a material that may withstand high temperatures, and evenly supplies fluid such as fuel and oxygen or air to the electrode, and is configured to precisely control the pressure and flow rate thereof.

In the context of the present disclosure, the meaning of insulation refers to providing a physical barrier to prevent electrical shorts or other electrical interference that may occur in an electrochemical reaction system. This insulating manifold is essential to ensure stable operation of systems such as SOFC or SOEC. To this end, the insulating plate maintains insulation even under high-temperature operating conditions, and prevents direct contact between the stack and the manifold, thereby enhancing the safety of the system and promoting an efficient energy conversion process. Therefore, the role of the insulating plate is to implement the insulation.

The base manifold has the first fluid conduit and the second fluid conduit extending therethrough, thereby providing a base for the manifold of the present disclosure and providing a passage for the inflow of fluid. The role of the housing is to define a space in which the stack, etc. may be accommodated. The housing may be combined with the base manifold to provide insulation and structural stability. The role of the first fluid conduit and the second fluid conduit is to provide a passage through which fluid such as air, oxygen, hydrogen, or water vapor flows into the space defined by the base manifold and the housing. The fluid may flow through the conduit and then enter the stack accommodated in the inner space or the fluid passage outside the stack.

In the context of the present disclosure, the meaning of the edge of the member refers to an end, an edge, a boundary line, or a joint portion where components meet each other. This edge may be designed so that the components may be accurately engaged with each other and stably fastened to each other. The meaning of the lower edge of the housing being fastened with the base manifold means that the lowest end of the vertical wall constitutes a joint portion where the housing meets the base manifold.

In one embodiment, the base manifold and the housing may be coupled to each other via a male-female coupling structure. In the context of the present disclosure, the meaning of the male-female coupling structure refers to a structure in which one component (female portion) is physically engaged with the other component (male portion) and stably coupled thereto. This coupling structure is essential for effectively coupling the base manifold and the housing to each other to maintain internal insulation and ensure the stability of the entire structure. This male-female coupling structure is made of a material with high strength and durability to withstand high temperature and pressure conditions, and thus plays a role in improving the efficiency and reliability of the electrochemical reaction system such as an SOFC or SOEC. This coupling scheme will be described later in the following embodiments.

In accordance with some embodiments of the insulating manifold for the electrochemical reaction, the housing includes: a first housing portion having an open bottom surface and having an open inner side surface and a closed outer side surface, wherein a lower edge of the first housing portion is coupled to the top of the base manifold; and a second housing portion adjacent to the first housing portion in a horizontal direction, wherein the second housing portion has an open bottom surface and has an open inner side surface and a closed outer side surface opposite to the closed outer side surface of the first housing portion, wherein a lower edge of the second housing portion is coupled to the top of the base manifold, wherein the first housing portion and the second housing portion are coupled to each other such that the open inner side surfaces thereof face each other and communicate with each other.

In accordance with some embodiments of the insulating manifold for the electrochemical reaction, the base manifold has a rail structure constructed to guide a sliding movement of each of the first housing portion and the second housing portion, wherein the rail structure includes both opposing rail structures respectively extending along and on both opposing sides of an upper surface of the base manifold, wherein both opposing lower edges of each of the first housing portion and the second housing portion are constructed to be slidably engaged with the both opposing rail structures, respectively. This slidable coupling of the lower edge to the rail structure will be described later in the following embodiments.

Another aspect of the present disclosure provides an electrochemical reaction system comprising: the insulating manifold of the first aspect as described above; and a stack received in the inner space so as to be disposed between the upper and lower insulating plates, wherein the stack is positioned so as not to cover at least one of the first fluid conduit or the second fluid conduit, wherein an upper sealing is disposed between the upper insulating plate and the housing, wherein a lower sealing is disposed between the lower insulating plate and the base manifold, wherein the stack includes a vertical arrangement of electrochemical cells, wherein the stack of the electrochemical cells includes a plurality of plate-shaped electrodes and a separator plate separating the plurality of plate-shaped electrodes from each other, wherein there is no electrical contact between the stack and the insulating manifold.

The stack refers to a vertical arrangement of the electrochemical cells such as SOFC or SOEC, and acts as a key component for electrochemical reaction. The stack reacts with fuel and oxygen, etc. via contact with the electrode, and generates electrical energy in the process or produces fuel such as hydrogen using the electrical energy.

The reason why the stack is accommodated in the inner space of the housing so as not to cover at least one of the first fluid conduit or the second fluid conduit is because the manifold of the present disclosure is an external manifold system in which at least one fluid is supplied from the fluid source out of the stack, into the housing, and enters the stack.

In accordance with some embodiments of the electrochemical reaction system, the electrochemical cell includes a SOFC (Solid Oxide Fuel Cell) or a SOEC (Solid Oxide Electrolysis Cell). In the context of the present disclosure, the meaning of SOFC or SOEC refers to an electrochemical reaction device operating at a high temperature, which converts fuel into electrical energy or produces fuel such as hydrogen using electrical energy, respectively. In order to operate efficiently, these devices require a uniform supply of fuel or oxygen, and it is important to appropriately manage the heat and electrical reaction generated during this process.

In accordance with some embodiments of the electrochemical reaction system, the base manifold is formed in a rectangular, circular, oval, or partially round shape. The above-described shapes and the like will be described in the following embodiments.

In accordance with some embodiments of the electrochemical reaction system, a pressing structure is further disposed on top of the stack and/or under the stack. In the context of the present disclosure, the pressing structure means a member that applies a pressure in the stacking direction of the cells in the stack to maintain the structural and functional stability of the stack. Therefore, a type of the pressing structure is not limited to a particular type as long as the pressing structure can apply the pressure to the stack. The pressing structure may apply pressure using a mass body, or may apply the pressure under the elastic force from an elastic body.

In accordance with some embodiments of the electrochemical reaction system, the at least one fluid conduit not covered with the stack among the first fluid conduit and the second fluid conduit includes a plurality of fluid conduits, wherein the system further includes a flow resistance structure constructed to at least partially block fluid flow from at least some of the plurality of fluid conduits to the others thereof. The reason why the flow resistance structure that at least partially blocks the fluid flow in the SOEC or SOFC is necessary is intended for uniform distribution and efficient management of the fluid. This flow resistance structure controls the inflow and outflow of the fluid, thereby maintaining and optimizing the balance of the electrochemical reaction occurring inside the stack. The partial blocking of the fluid flow may allow the reaction gas inside the stack to be prevented from being excessively concentrated or unevenly distributed, which plays an important role in improving the performance and efficiency of the entire system.

In accordance with some embodiments of the electrochemical reaction system, the flow resistance structure includes: a first flow resistance structure disposed on one of at least some of layers of the stack and the housing; and a second flow resistance structure disposed on the other of the at least some of the layers of the stack and the housing.

In accordance with some embodiments of the electrochemical reaction system, the flow resistance structure further includes an insulating portion disposed between the first flow resistance structure and the second flow resistance structure.

In accordance with some embodiments of the electrochemical reaction system, the first flow resistance structure and the second flow resistance structure are movable relative to each other. Under this relative movement, the flow resistance structure including the first flow resistance structure and the second flow resistance structure may control an amount by which the fluid flow is blocked. Such a structure will be described in the following embodiments.

In accordance with some embodiments of the electrochemical reaction system, the relative movement between the first flow resistance structure and the second flow resistance structure is implemented using a pinion extending in a direction perpendicular to a direction of the relative movement and a rack structure a gear meshing with the pinion. Such a structure will be described in the following embodiments.

The following describes examples of the present disclosure. However, the examples as described below are merely embodiments of the present disclosure, and the scope of the present disclosure is not limited to the examples as set forth below.

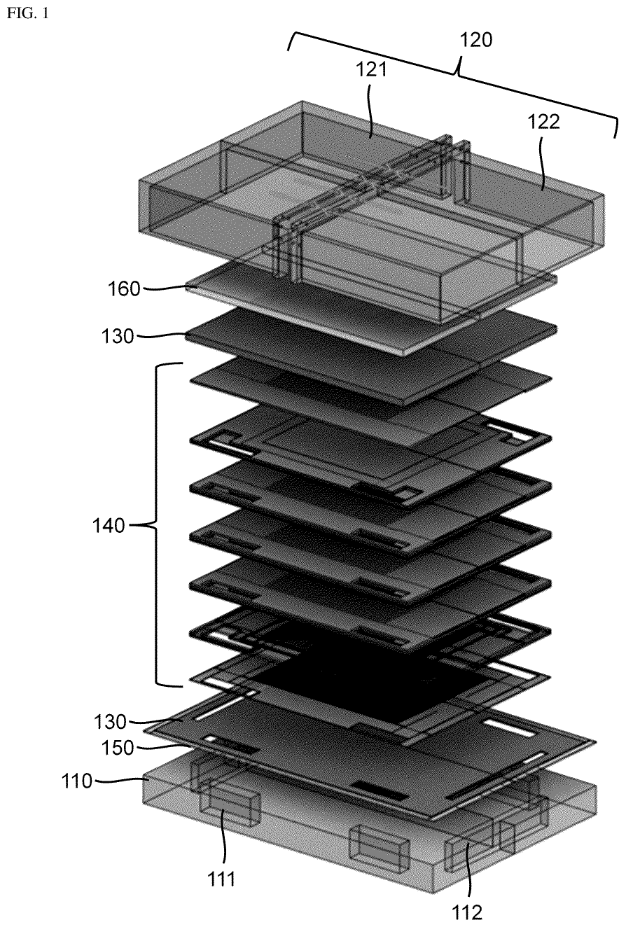

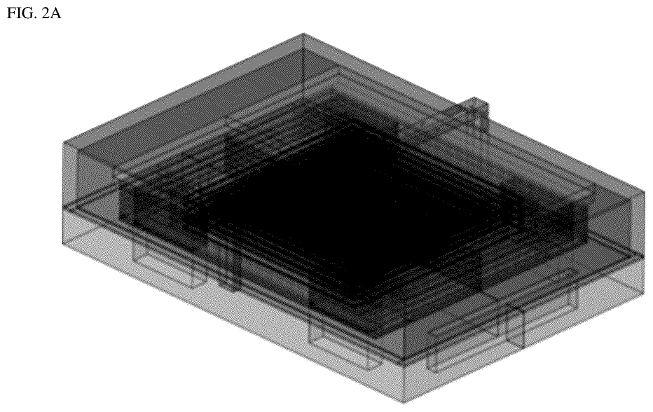

FIG. 1 is a diagram illustrating an example of an electrochemical reaction system according to an embodiment of the present disclosure. FIG. 2A is a diagram showing an assembled state of a manifold. FIG. 2B is a diagram showing a disassembled state of a manifold. FIG. 2C is a diagram showing a cross-section of a manifold.

Referring to FIG. 1, FIG. 2A, FIG. 2B, and FIG. 2C together, the insulating manifold for an electrochemical reaction is shown, wherein the insulating manifold is configured to receive gas from an external source. The insulating manifold comprises: a plate-shaped base manifold 110 having at least a first fluid conduit 111 and a second fluid conduit 112 extending therethrough vertically; a housing 120 disposed on top of the base manifold 110 and having a vertical wall and an open bottom surface, wherein a lower edge of the housing 120 is coupled to a top of the base manifold; and upper and lower insulating plates 130 respectively defining an upper surface and a lower surface of an inner space defined by the base manifold 110 and the housing 120.

The housing 120 includes: a first housing portion 121 having an open bottom surface and having an open inner side surface and a closed outer side surface, wherein a lower edge of the first housing portion 121 is coupled to the top of the base manifold; and a second housing portion 122 adjacent to the first housing portion 121 in a horizontal direction, wherein the second housing portion 122 has an open bottom surface and has an open inner side surface and a closed outer side surface opposite to the closed outer side surface of the first housing portion 121, wherein a lower edge of the second housing portion 122 is coupled to the top of the base manifold, wherein the first housing portion 121 and the second housing portion 122 are coupled to each other such that the open inner side surfaces thereof face each other and communicate with each other. In FIG. 1, the stack housing 120 is illustrated as being composed of two parts which are coupled to each other with bolts/nuts. However, this is an example, and the above-mentioned coupling scheme is not limited to a bolt/nut scheme, and the stack housing 120 may be embodied as a one-piece depending on the coupling scheme to the base manifold.

The stack 140 is the central component of the electrochemical reaction system, composed of a vertical arrangement of multiple electrochemical cells, such as solid oxide fuel cells or solid oxide electrolysis cells. The insulating plate 130 is located on both the upper and lower sides of stack 140 to form an electrically insulated inner space. The insulating plate 130 prevents the stack from coming into direct electrical contact with external components, avoiding the risk of electrical short circuits.

The lower sealing 150 is positioned between the lower insulating plate 130 and the base manifold 110. The upper sealing, though not shown in FIG. 1, is located between the upper insulating plate 130 and the housing 120. Pressure plate 160 is installed on the top of the stack 140 to apply mechanical pressure.

In one embodiment of the present invention, the lower sealing 150 may be positioned between the lower insulating plate 130 and the base manifold 110. However, the arrangement of the lower sealing 150 is not limited to this configuration. The lower sealing 150 and the lower insulating plate 130 may also be designed to have the same height and to be located on a single plane. The arrangement of the lower sealing 150 and the lower insulating plate 130 may vary depending on the design and manufacturing approach. Although the figures illustrate a specific embodiment, the drawings are not intended to limit the scope of the invention, and the invention includes various modifications and design alternatives within the technical spirit and scope of the present invention.

In one embodiment of the present invention, the upper sealing may be positioned between the upper insulating plate and the housing. However, the arrangement of the upper sealing is not limited to this specific configuration. The upper sealing and the upper insulating plate may also be designed to be the same height and to be located on a single plane. The arrangement of the upper sealing and the upper insulating plate may vary depending on the design and manufacturing approach. Although the figures illustrate a specific embodiment, the drawings are not intended to restrict the scope of the invention, and the invention encompasses various modifications and design alternatives within the technical spirit and scope of the present invention.

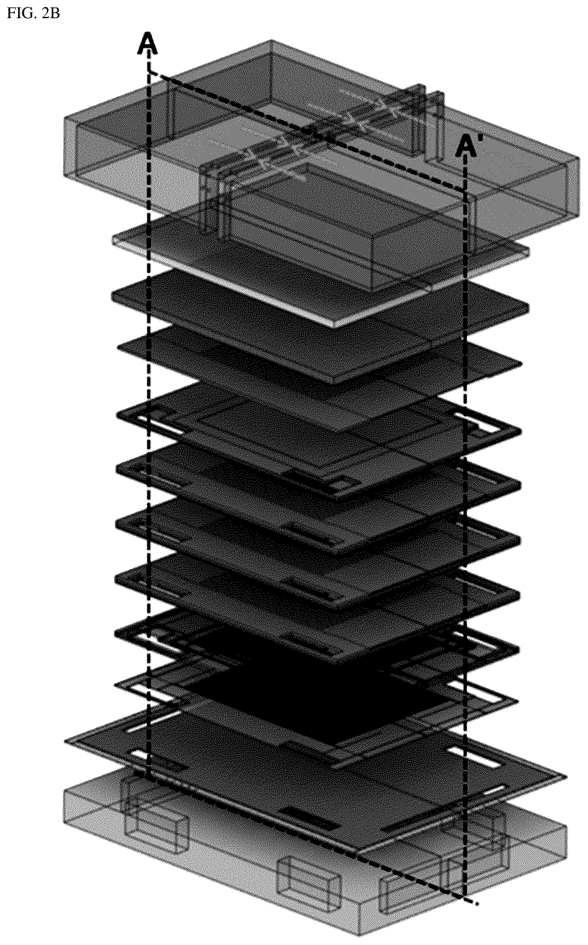

FIG. 3A is a diagram showing a scheme of supplying fuel to a stack of the electrochemical reaction system according to an embodiment of the present disclosure. FIG. 3B is a diagram showing a scheme of supplying air to a stack of the electrochemical reaction system according to an embodiment of the present disclosure.

Referring to FIG. 1, FIG. 3A and FIG. 3B together, a scheme of supplying two or more fluids through a plurality of fluid conduits formed in the base manifold and a fluidic connection relationship of the stack 140 may be identified. FIG. 3A and FIG. 3B specifies a fuel and air supply scheme. However, the electrochemical reaction system of the present disclosure is not limited to the above types of the fluids.

### Manifold Shape

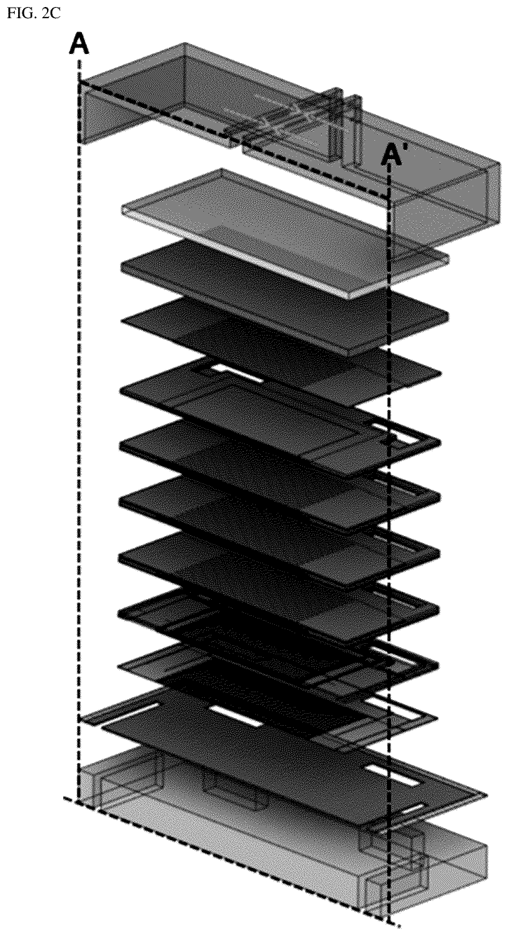

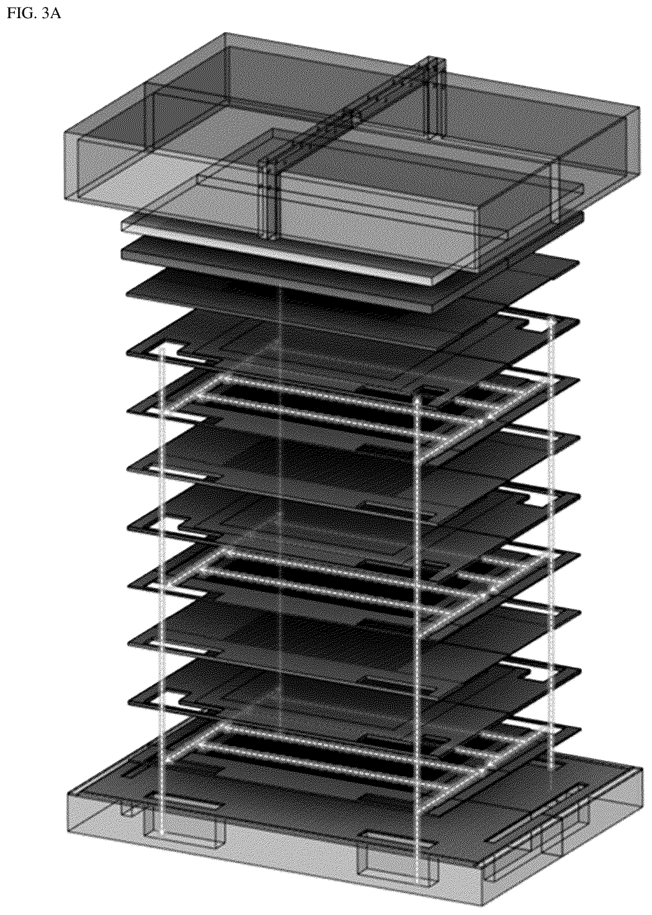

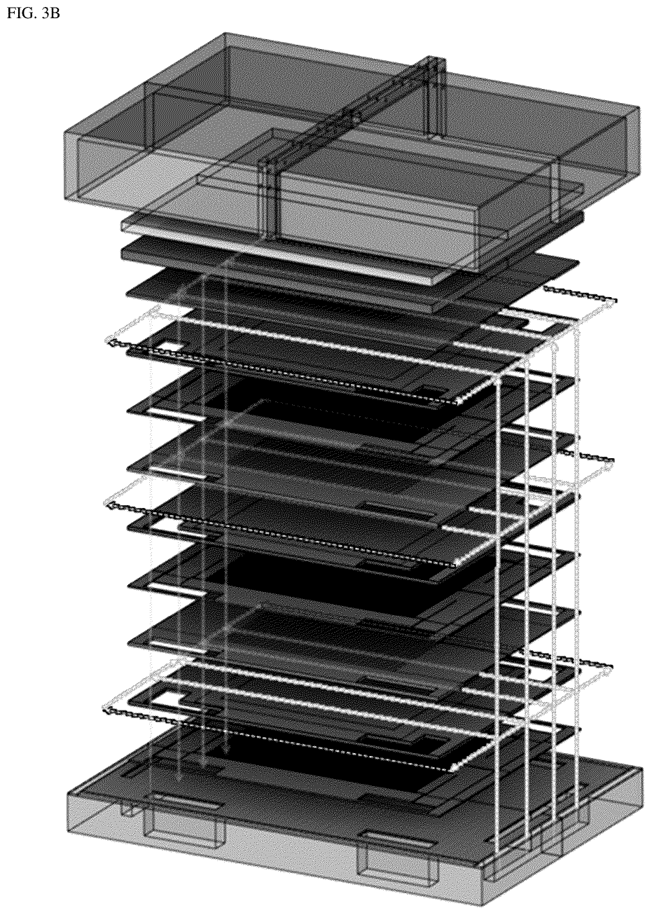

FIGS. 4 to 6 are diagrams illustrating various shapes of manifolds. FIG. 4 illustrates an example in which the manifold shape is defined as an oval. FIG. 5 illustrates an example in which the manifold shape is defined as a circular shape. FIG. 6 illustrates an example in which the manifold shape is defined as a partially round shape. In this way, the electrochemical reaction system and the manifold according to an embodiment of the present disclosure are not particularly limited in shape or structure as long as they include the functionally described members. FIGS. 4 to 6 illustrate only three shapes. However, this does not limit the scope of the present disclosure.

### Fastening Scheme Between Base Manifold and Housing

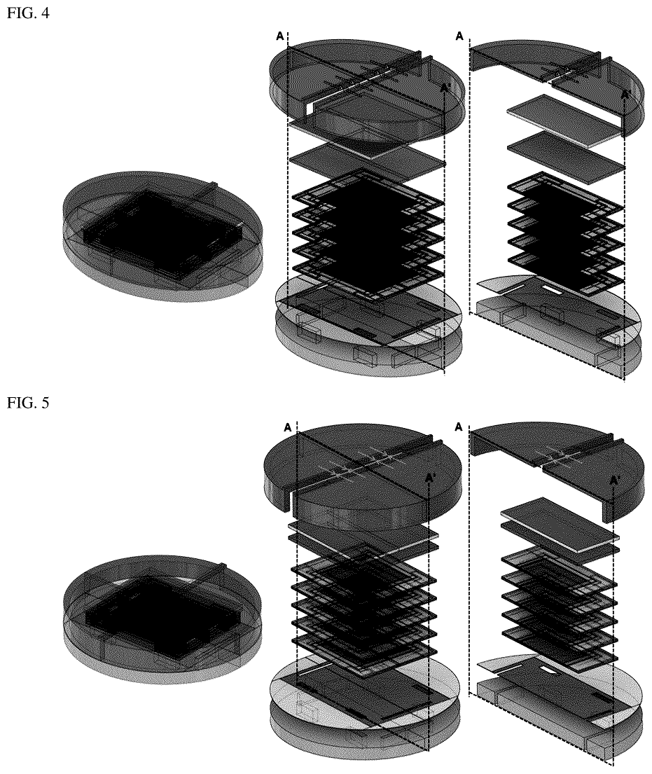

FIG. 7 is a diagram showing an example of a scheme of coupling a base manifold and a housing to each other. The base manifold and the housing are coupled to each other via a male-female coupling structure. Referring to FIG. 7 with FIG. 1, the base manifold 110 and the housing 120 may be fastened to each other in a manner such that that a protruding structure that protrudes from one of the base manifold 110 and the housing 120 is inserted into a groove formed in the other of the base manifold and the housing. In this case, the housing may be formed as an integral body.

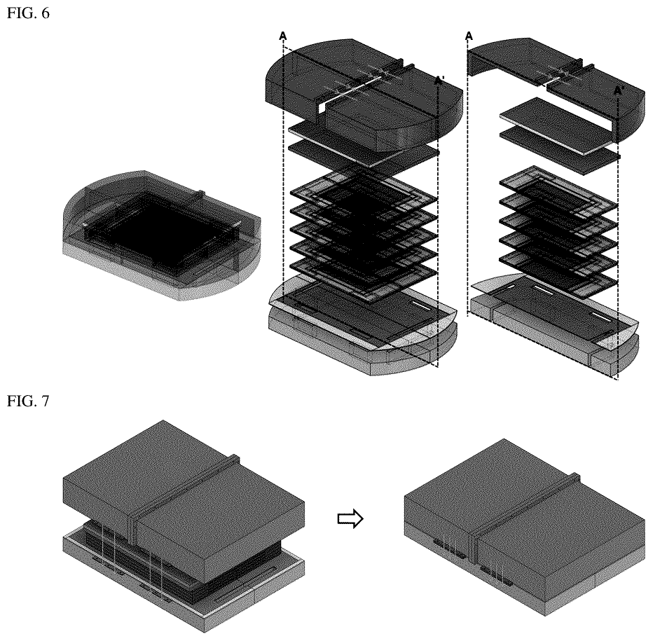

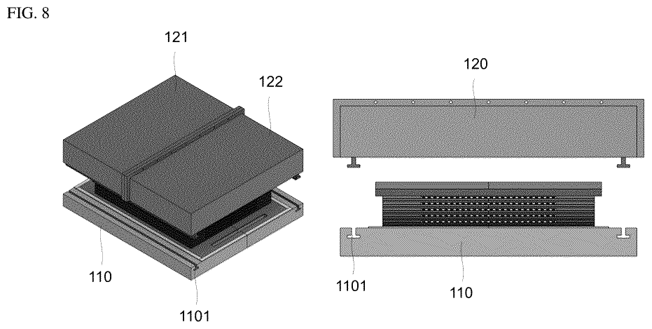

FIG. 8 and FIG. 9 are diagrams showing another example of coupling a base manifold and a housing to each other. Referring to FIG. 8 and FIG. 9, in accordance with some embodiments of the insulating manifold for the electrochemical reaction, the base manifold 110 has a rail structure 1101 constructed to guide a sliding movement of each of the first housing portion 121 and the second housing portion 122, wherein the rail structure 1101 includes both opposing rail structures respectively extending along and on both opposing sides of an upper surface of the base manifold 110, wherein both opposing lower edges of each of the first housing portion 121 and the second housing portion 122 are constructed to be slidably engaged with the both opposing rail structures 1101, respectively. The two parts, that is, the first and second housing portions of the housing may be fastened to each other via a male-female fastening structure, etc.

### Formation of Resistance Structure

In the electrochemical reaction system according to an embodiment of the present disclosure, the flow of fluid may be interrupted or blocked as needed. The purpose of such interruption or blocking of the fluid flow is the same as described above. The flow of fluid is shown in FIG. 3A or FIG. 3B.

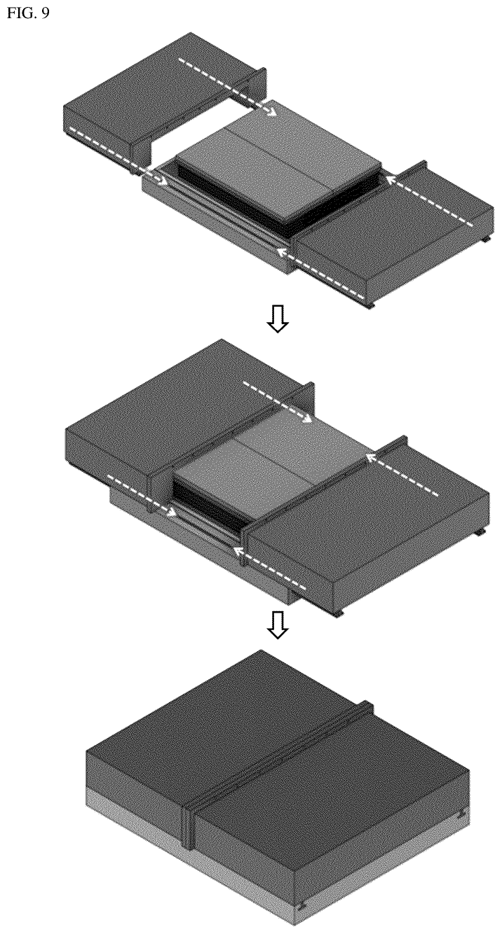

FIG. 10A is a perspective view illustrating the arrangement of the flow resistance structure that impedes or blocks flow of fluid in the electrochemical reaction system of the present disclosure. FIG. 10B is a plan view showing the structure of the flow resistance structure. Referring to FIG. 10A and FIG. 10B, a protrusion structure 1102 is formed on each of the separator plate and the housing, so that the fluid flow path becomes narrower and the flow length becomes larger compared to when each protrusion structure 1102 is not present, and thus the fluid flow may be interrupted or completely blocked as needed.

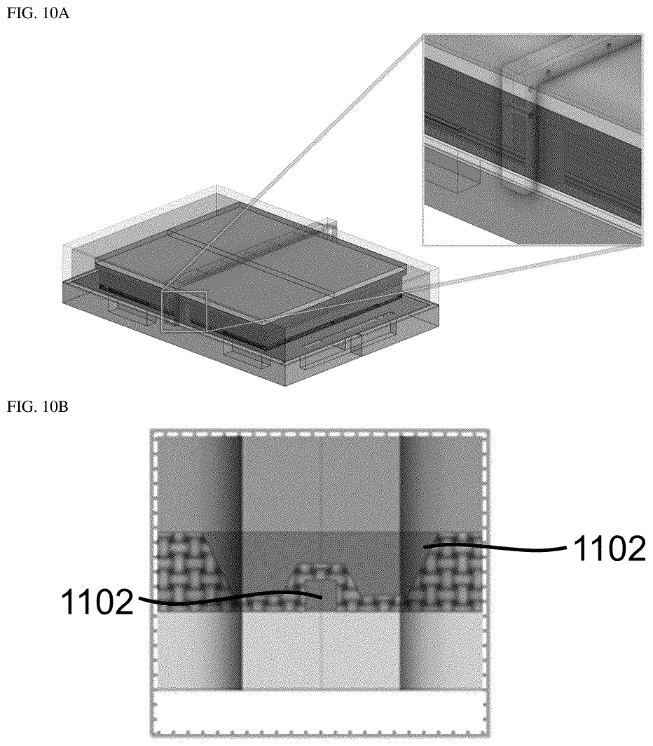

FIG. 11A is a perspective view illustrating the arrangement of another example of a flow resistance structure in the electrochemical reaction system of the present disclosure. FIG. 11B is a plan view showing the structure of the flow resistance structure. Referring to FIG. 11A and FIG. 11B, the protrusion structure 1102 is formed on each of the separator plate and the housing in the same manner as in FIG. 10B. However, in FIG. 11B, an insulating material 1103 is additionally formed between the protrusion structures 1102 of the separator and the housing, so that the insulation between the stack and the housing as the purpose of the present disclosure may be more reliably ensured.

In FIG. 10A, FIG. 10B, FIG. 11A, and FIG. 11B, the flow resistance structure is fixed and thus, an amount by which the structure blocks the flow of fluid is not adjustable.

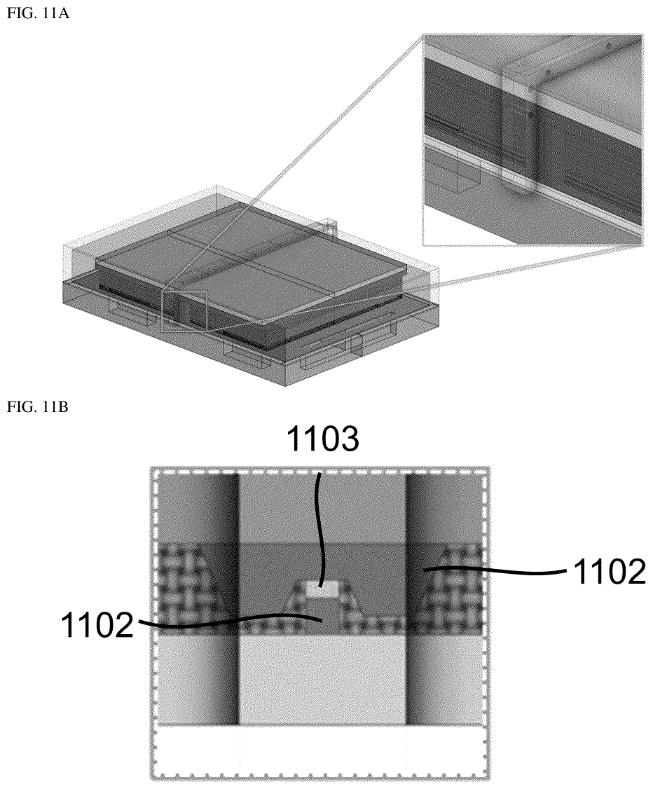

FIG. 12 is a diagram illustrating an example of a flow resistance structure implemented using a rack-and-pinion gear system within the electrochemical reaction system of the present disclosure. Referring to FIG. 12, the flow resistance structure 1106 is controlled by a rack 1104 and a pinion gear 1105. The rack 1104 moves linearly along the flow path, while the pinion gear 1105 engages with the rack to enable precise adjustment of the flow resistance structure 1106. This mechanism allows for variable control of the fluid flow by changing the position of the flow resistance structure 1106. By adjusting the interaction between the rack 1104 and the pinion 1105, the system can optimize pressure and flow distribution, ensuring efficient and stable operation under various stack conditions.

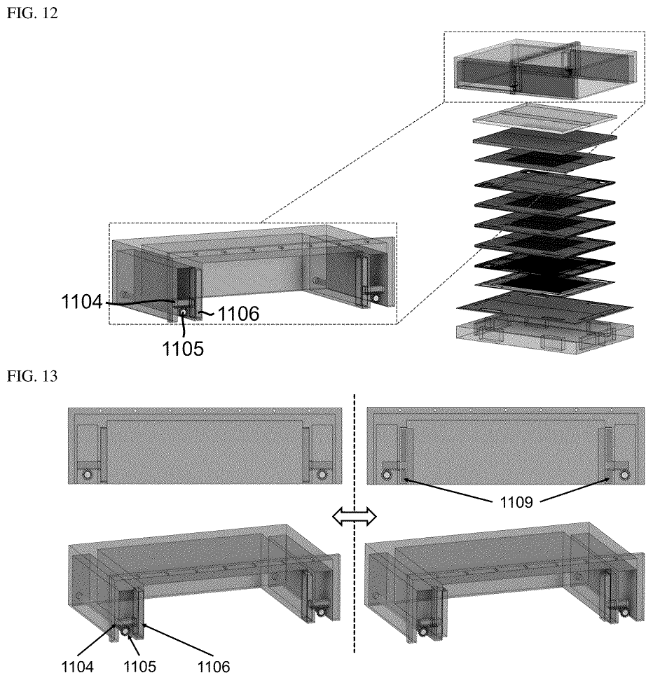

FIG. 13 is a diagram illustrating the operation of the flow resistance structure using a rack-and-pinion gear system within the electrochemical reaction system of the present disclosure. Referring to FIG. 13, the flow resistance structure 1106 is positioned within a space 1109 that allows its linear movement. The rack 1104 is designed to move linearly along the flow path, guided by the space 1109, while the pinion gear 1105 interacts with the rack 1104 to control its movement. The rotational motion of the pinion 1105 translates into linear motion of the rack 1104, thereby adjusting the position of the flow resistance structure 1106. This mechanism enables precise control of fluid flow by altering the extent to which the flow resistance structure 1106 obstructs the passage within the flow path, ensuring optimized pressure and flow distribution for varying operational requirements of the stack.

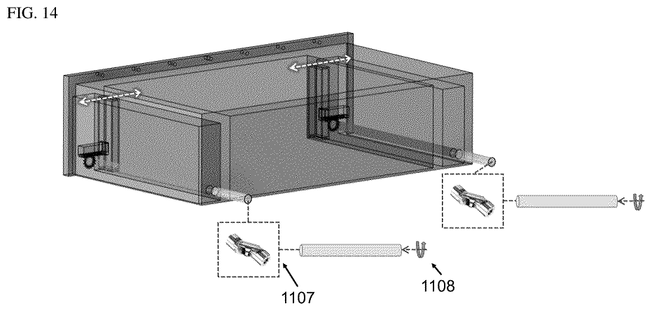

FIG. 14 is a diagram illustrating the operation of the rack-and-pinion gear system controlled by an external driving force transmitted through a universal joint in the electrochemical reaction system of the present disclosure. Referring to FIG. 14, the universal joint 1107 connects the pinion gear system to an external driving force 1108. The universal joint 1107 allows for the transfer of rotational motion to the pinion gear, even when the axis of rotation is not perfectly aligned, enabling smooth operation in various spatial configurations. The driving force 1108, such as a motor or a manual actuator, rotates the pinion gear, which engages with the rack to produce linear movement. This linear motion adjusts the position of the flow resistance structure, allowing precise control over the fluid flow within the system. The use of the universal joint 1107 ensures flexibility in the placement of the driving force 1108 while maintaining efficient transmission of motion.

Referring to FIGS. 12 to 14 together, in accordance with some embodiments of the electrochemical reaction system, the flow resistance structure includes: a first flow resistance structure disposed on one of at least some of layers of the stack and the housing; and a second flow resistance structure disposed on the other of the at least some of the layers of the stack and the housing. In accordance with some embodiments of the electrochemical reaction system, the flow resistance structure further includes an insulating portion disposed between the first flow resistance structure and the second flow resistance structure. In accordance with some embodiments of the electrochemical reaction system, the first flow resistance structure and the second flow resistance structure are movable relative to each other. In accordance with some embodiments of the electrochemical reaction system, the relative movement between the first flow resistance structure and the second flow resistance structure is implemented using a pinion 1105 extending in a direction perpendicular to a direction of the relative movement and a rack 1104 structure a gear meshing with the pinion 1105. Thus, an amount by which the structure blocks the flow of fluid is not adjustable.

In particular, as illustrated in FIG. 14, the manifold and the housing of the present disclosure provide a closed system, so that the rack-and-pinion 1104, 1105 structure may be configured to operate upon application of a driving force 1108 thereto.

Although the embodiments of the present disclosure have been described above with reference to the accompanying drawings, the present disclosure may not be limited to the embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that the embodiments as described above are not restrictive but illustrative in all respects.

What is claimed is:

1. An insulating manifold for an electrochemical reaction, wherein the insulating manifold is configured to receive gas from an external source, wherein the insulating manifold comprises:
a plate-shaped base manifold having at least a first fluid conduit and a second fluid conduit extending therethrough vertically;
a housing disposed on top of the base manifold and having a vertical wall and an open bottom surface, wherein a lower edge of the housing is coupled to a top of the base manifold; and
upper and lower insulating plates respectively defining an upper surface and a lower surface of an inner space defined by the base manifold and the housing.

2. The insulating manifold for the electrochemical reaction of claim 1, wherein the housing includes:
a first housing portion having an open bottom surface and having an open inner side surface and a closed outer side surface, wherein a lower edge of the first housing portion is coupled to the top of the base manifold; and
a second housing portion adjacent to the first housing portion in a horizontal direction, wherein the second housing portion has an open bottom surface and has an open inner side surface and a closed outer side surface opposite to the closed outer side surface of the first housing portion, wherein a lower edge of the second housing portion is coupled to the top of the base manifold,
wherein the first housing portion and the second housing portion are coupled to each other such that the open inner side surfaces thereof face each other and communicate with each other.

3. The insulating manifold for the electrochemical reaction of claim 1, wherein the base manifold and the housing are coupled to each other via a male-female coupling structure.

4. The insulating manifold for the electrochemical reaction of claim 2, wherein the base manifold has a rail structure constructed to guide a sliding movement of each of the first housing portion and the second housing portion,
wherein the rail structure includes both opposing rail structures respectively extending along and on both opposing sides of an upper surface of the base manifold,
wherein both opposing lower edges of each of the first housing portion and the second housing portion are constructed to be slidably engaged with the both opposing rail structures, respectively.

5. An electrochemical reaction system comprising:
the insulating manifold according to claim 1; and
a stack received in the inner space so as to be disposed between the upper and lower insulating plates,
wherein the stack is positioned so as not to cover at least one of the first fluid conduit or the second fluid conduit,
wherein an upper sealing is disposed between the upper insulating plate and the housing,
wherein a lower sealing is disposed between the lower insulating plate and the base manifold,
wherein the stack includes a vertical arrangement of electrochemical cells,
wherein the stack of the electrochemical cells includes a plurality of plate-shaped electrodes and a separator plate separating the plurality of plate-shaped electrodes from each other,
wherein there is no electrical contact between the stack and the insulating manifold.

6. The electrochemical reaction system of claim 5, wherein the electrochemical cell includes a SOFC (Solid Oxide Fuel Cell) or a SOEC (Solid Oxide Electrolysis Cell).

7. The electrochemical reaction system of claim 5, wherein the base manifold is formed in a rectangular, circular, oval, or partially round shape.

8. The electrochemical reaction system of claim 5, wherein a pressing structure is further disposed on top of the stack and/or under the stack.

9. The electrochemical reaction system of claim 5, wherein the at least one fluid conduit not covered with the stack among the first fluid conduit and the second fluid conduit includes a plurality of fluid conduits,
wherein the system further includes a flow resistance structure constructed to at least partially block fluid flow from at least some of the plurality of fluid conduits to the others thereof.

10. The electrochemical reaction system of claim 9, wherein the flow resistance structure includes:
a first flow resistance structure disposed on one of at least some of layers of the stack and the housing; and
a second flow resistance structure disposed on the other of the at least some of the layers of the stack and the housing.

11. The electrochemical reaction system of claim 10, wherein the flow resistance structure further includes an insulating portion disposed between the first flow resistance structure and the second flow resistance structure.

12. The electrochemical reaction system of claim 10, wherein the first flow resistance structure and the second flow resistance structure are movable relative to each other.

13. The electrochemical reaction system of claim 12, wherein the relative movement between the first flow resistance structure and the second flow resistance structure is implemented using a pinion extending in a direction perpendicular to a direction of the relative movement and a rack structure a gear meshing with the pinion.
